(19) United States
(12) Patent Application Publication
(10) Pub. No.: US 2007/0065683 A1
(43) Pub. Date: Mar. 22, 2007

(54) Magnetic recording medium, method of manufacturing the same, and magnetic recording/reproducing apparatus

(75) Inventors: Koji Sonoda, Ome-shi (JP); Hiroyuki Hieda, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/520,653

(22) Filed: Sep. 14, 2006

(30) Foreign Application Priority Data
Sep. 20, 2005 (JP) 2005-272522

(51) Int. Cl. G11B 5/72; B05D 5/12

(52) U.S. Cl. 428/833.2; 360/131; 428/835.5; 428/835.6; 427/127

(57) ABSTRACT

According to one embodiment, a magnetic recording medium includes a protective layer having a plurality of projections on its surface. These projections are formed by forming an etching mask including a mask underlayer and a mask pattern layer having an island structure on the protective layer, and performing dry etching after that.

### CROSS-REFERENCE TO RELATED APPLICATIONS

This application is based upon and claims the benefit of priority from Japanese Patent Application No. 2005-272522, filed Sep. 20, 2005, the entire contents of which are incorporated herein by reference.

### BACKGROUND

1. Field

One embodiment of the invention relates to a magnetic recording medium for use in, e.g., a hard disk drive using a magnetic recording technique, a method of manufacturing the same, and a magnetic recording/reproducing apparatus using the same.

2. Description of the Related Art

As a means for increasing the recording density of a magnetic recording/reproducing apparatus, it is possible to narrow the spacing between the head and disk. To this end, in addition to decreasing the surface roughness of the disk, it is being attempted to change the system of the magnetic recording/reproducing apparatus from a flying system which performs recording/reproduction by flying the head from a rotating magnetic disk, to an ultra-low flying magnetic head system by which the head is moved close to a distance of ten-odd nm or less to a rotating magnetic disk, or a contact system by which the head is continuously brought into contact with a rotating magnetic disk.

If this spacing is reduced, however, wear and dynamic attraction of the head occur. It is disclosed by, for example, a technique which solves this problem is described in, e.g., Jpn. Pat. Appln. KOKAI Publication No. 60-263330. In this technique, in order to stabilize the lubricating properties between the head and medium surface for long periods, fine projections are formed on the magnetic disk surface by a patterned protective film to form lubricant reservoirs between these projections, thereby alleviating the wear and dynamic attraction of the head. Unfortunately, these fine projections come into contact with the recording/reproducing element during contact recording and reproduction, thereby generating heat. Especially when a magnetoresistive effect (MR) element is used, a phenomenon called thermal asperity in which a reproduced signal is abnormalized by the heat occurs.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a flowchart for explaining an embodiment of a magnetic recording medium manufacturing method according to a first embodiment of the invention;

FIG. 2 is a schematic sectional view for explaining the embodiment of the magnetic recording medium manufacturing method according to a first embodiment of the invention;

FIG. 3 is a schematic sectional view for explaining the embodiment of the magnetic recording medium manufacturing method according to a first embodiment of the invention;

FIG. 4 is a schematic sectional view for explaining the embodiment of the magnetic recording medium manufacturing method according to a first embodiment of the invention;

FIG. 5 is a schematic sectional view for explaining the embodiment of the magnetic recording medium manufacturing method according to a first embodiment of the invention;

FIG. 6 is a schematic sectional view for explaining the embodiment of the magnetic recording medium manufacturing method according to a first embodiment of the invention;

FIG. 7 is a schematic sectional view for explaining the embodiment of the magnetic recording medium manufacturing method according to a first embodiment of the invention; and

FIG. 8 is a schematic view showing the arrangement of an example of a magnetic recording/reproducing apparatus according to a first embodiment of the invention.

### DETAILED DESCRIPTION

Various embodiments according to the invention will be described hereinafter with reference to the accompanying drawings. In general, the present invention is roughly classified into inventions according to first to fifth aspects to be described below.

A magnetic recording medium according to a first invention comprises a substrate, a magnetic recording layer formed on the substrate, and a protective layer formed on the magnetic recording layer, having a plurality of projections formed on its surface, and substantially made of diamond-like carbon, wherein the projections are formed by forming, on the protective layer, an etching mask comprising a mask underlayer and a mask pattern layer having an island structure, and performing dry etching by using this etching mask after that.

A magnetic recording medium according to a second invention comprises a substrate, a magnetic recording layer formed on the substrate, and a protective layer having a plurality of projections formed on its surface, and substantially made of diamond-like carbon, wherein the average plane area of the summits of the projections viewed in a direction perpendicular to the medium surface is 1 μm² or less.

A magnetic recording/reproducing apparatus according to the third invention comprises the magnetic recording medium according to the first invention, and a magnetic recording/reproducing head having an MR element.

A magnetic recording/reproducing apparatus according to a fourth invention comprises the magnetic recording medium according to the second invention, and a magnetic recording/reproducing head having an MR element.

A fifth invention provides a method of manufacturing the above-mentioned magnetic recording medium, comprising steps of forming a magnetic recording layer on a substrate, forming a protective layer substantially made of diamond-like carbon on the magnetic recording layer, forming a mask underlayer on the protective layer, forming a mask pattern layer having an island structure on the mask underlayer to obtain an etching mask, and performing dry etching by using the etching mask to form a plurality of projections on the surface of the protective layer.

In the first, third, and fifth inventions, the mask pattern layer is formed on the protective layer via the mask underlayer. This makes it possible to control the shape of the mask pattern layer so as to form a fine island structure, compared to a case in which the mask pattern layer is directly formed on the protective layer. Since fine projections form on the surface of the dry-etched protective layer, it is possible to reduce the contact area between the head and projections, and suppress thermal asperity (TA).

In the second and fourth inventions, a protective film having a plurality of projections having an average summit plane area of 1 μm² or less is formed on the surface of the magnetic recording medium. Accordingly, it is possible to reduce the contact area between the head and projections, and suppress thermal asperity.

The present invention will be explained in more detail below with reference to the accompanying drawing.

FIG. 1 shows a manufacturing step flowchart for explaining an embodiment of a magnetic recording medium manufacturing method according to the present invention.

FIGS. 2 to 6 illustrate schematic sectional views for explaining the embodiment of the magnetic recording medium manufacturing method according to the present invention.

First, a nonmagnetic substrate is prepared. As this nonmagnetic substrate, it is preferable to use, e.g., a glass substrate, metal substrate, plastic substrate, or Si substrate.

It is also possible to use a substrate obtained by forming an underlayer such as a metal film or dielectric film on the surface of the nonmagnetic substrate described above.

When a magnetic recording medium for perpendicular magnetic recording is to be formed, a soft magnetic underlayer can be formed between the underlayer and nonmagnetic substrate.

The shape of the substrate can be a disk, and the diameter of the disk is, e.g., 0.85, 1, 1.8, 2.5, or 3 inches. The flatness of the substrate is desirably as high as possible.

Then, as shown in FIG. 2, a magnetic recording layer 2 is formed on a substrate 1 (S1).

A ferromagnetic material is used as this magnetic recording layer. The ferromagnetic material contains at least one ferromagnetic metal selected from the group consisting of Co, Fe, and Ni. More specifically, in addition to this ferromagnetic metal, the ferromagnetic material further contains at least one metal selected from the group consisting of C, Si, Cr, Pt, Pd, Ta, Tb, Sm, and Gd. The magnetic recording layer can be formed on the substrate by sputtering. Also, a multilayered structure of an arbitrary ferromagnetic material can be used as the magnetic recording layer. Furthermore, a metal film or metal oxide film except for Co, Fe, and Ni can be inserted between the ferromagnetic material layers of this multilayered structure.

After that, as shown in FIG. 3, a protective layer 3 made of a diamond-like carbon film is formed on the magnetic recording layer 2 (S2).

The diamond-like carbon film has an SP³ structure as its main component, and can contain oxygen, hydrogen, nitrogen, and the like. The diamond-like carbon film can be formed by, e.g., sputtering, CVD, or ion beam evaporation.

An etching stop layer may also be formed on the protective layer 3. As this etching stop layer, it is possible to use, e.g., a Pt, Si, SiC, or alumina layer.

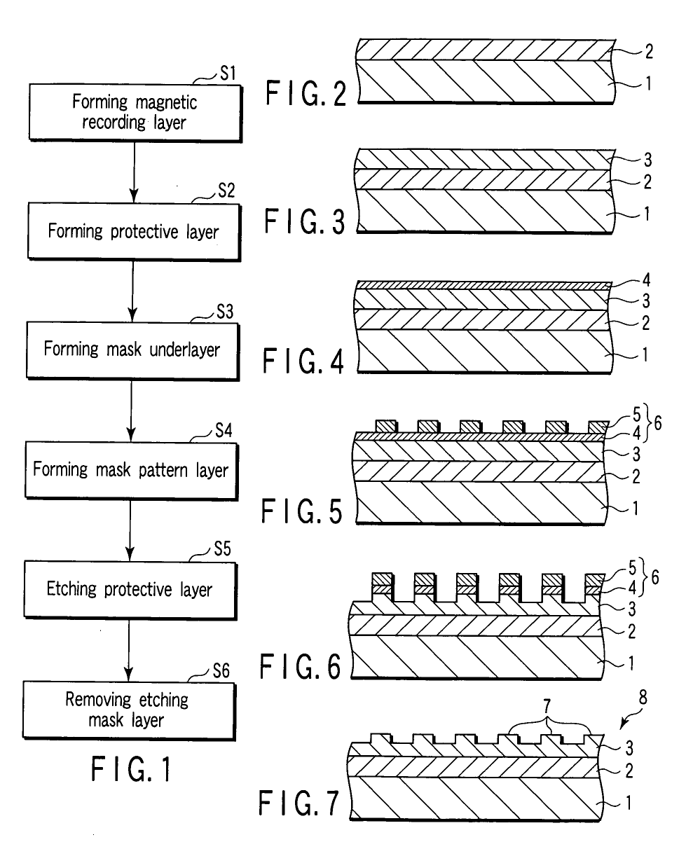

Furthermore, as shown in FIG. 4, a mask underlayer 4 is formed on the protective layer 3 (S3).

Desirable characteristics of the mask underlayer 4 are that the affinity to the material of a mask pattern layer to be formed on the surface of the mask underlayer 4 is lower than that to the diamond-like carbon film, so a fine island structure readily forms when the mask pattern layer is formed. The use of the mask underlayer makes it possible to control the shape of the mask pattern layer so as to form a fine island structure, compared to a case in which the mask pattern layer is directly formed on the protective layer.

Examples of the mask underlayer material are a metal, metal oxide, metal nitride, and organic molecular material.

Examples of the metal are Si, Ti, and W.

This is so because these metals can be easily removed by dry etching using an etching gas such as CF₄.

Examples of the metal oxide and metal nitride are SiO₂, Si₃N₄, TiO, and Al₃O₄, because these compounds are readily removable by the use of a fluorine-based etching gas.

When any of the metal, metal oxide, and metal nitride described above is used as the mask underlayer, the affinity to the mask pattern layer can be controlled by modifying the surface of the mask underlayer by a silane coupling agent or the like.

Examples of the organic molecular film are a polymer film and organic molecular deposited film formable by coating.

Examples of the polymer film material capable of forming the mask underlayer by coating are a hydrocarbon-based polymer, fluorocarbon-based polymer, and siloxane-based polymer.

As the hydrocarbon-based polymer, it is possible to use, e.g., polystyrene (PS), polymethylmethacrylate (PMMA), polyimide, novolak resin, polyethylene, polybutadiene, polyisoprene, or polyethylene oxide.

As the siloxane-based polymer, polydimethylsiloxane or the like can be used. It is also possible to use a polymeric glass material called spin on glass. When the siloxane-based polymer is to be used, a pattern can be transferred onto the protective film by dry etching and then selectively removed by dry etching using, e.g., CF₄ or CHF₃.

As the fluorocarbon-based polymer, a perfluoroether-based polymer often used as a lubricant can be used. Examples of known products are Fomblin and Krytox.

It is possible to dissolve any of these polymer materials in an appropriate solvent, and form a coating layer on the protective layer by using a coating method such as spin coating or dipping.

It is also possible to form a surface layer on the mask underlayer by using a photo setting resin or thermosetting resin, and form an etching mask layer on this surface layer, thereby preventing mixing of the mask underlayer and etching mask layer.

The surface layer may also be formed by using a silane coupling agent such as octadecyltrichlorosilane, octadecyltriethoxysilane, or octadecyltrimethoxysilane. Since a monolayer of the silane coupling agent can be modified, a very thin mask underlayer can be formed.

As the fluorocarbon-based polymer, it is also possible to use a polymer produced in a plasma of a fluorocarbon-based gas such as CF₄ or CHF₃. When this plasma polymer is used, a mask underlayer can be formed in a vacuum environment. This increases the efficiency because the magnetic recording layer, protective layer, and mask underlayer can be successively formed consistently in a vacuum. The surface may also be modified by using a fluorocarbon chain silane coupling agent having a reaction group such as trimethoxysilane, triethoxysilane, or trichlorosilane as this polymer layer.

As the organic deposited film material, it is possible to use an organic compound having a molecular weight lower than that of the polymer film material described above. Examples are: tetratriphenylaminoethylene, (TTPAE) e.g., tetra(N,N-diphenyl-4-aminophenyl)ethylene represented by formula (1) below, TPD: triphenyldiamine, e.g., N,N-7-bis-(4-methylphenyl)-N,N-7-bis-phenyl)-benzidine represented by formula (2) below, and Alq3: trishydroxyquinolinoaluminum, e.g., tris(8-hydroxyquiolino)-aluminum represented by formula (3) below.

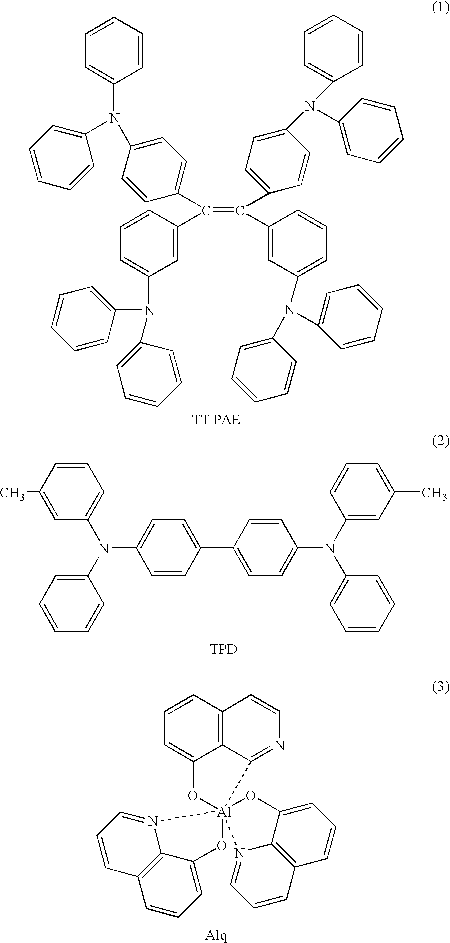

The mask underlayer may also be planarized by depositing any of these organic compounds on the protective layer, and annealing the compound. A film can be formed on the protective layer by sublimating any of these low-molecular organic compounds by heating at a low temperature of 400° C. or less. When this low-molecular organic compound deposited film is used as the mask underlayer, the efficiency increases because the magnetic recording layer, protective layer, and mask underlayer can be successively formed consistently in a vacuum environment. Also, the fluorine-based polymer is desirable since its low surface energy facilitates forming a droplet-like island structure by repelling the mask layer material formed on it.

Then, as shown in FIG. 5, a mask pattern layer 5 is formed on the mask underlayer 4 (S4). In this manner, an etching mask 6 having the mask underlayer 4 and mask pattern layer 5 is obtained.

The mask pattern layer 5 is formed by using self-organized pattern formation of an organic molecular material.

In its formation process, an organic molecular film generally tends to form a droplet-like island structure, rather than a film structure having a uniform film thickness, by the surface energy of the material forming the film. The present invention uses an island structure readily formable in a thin film of the organic molecular material.

Like a resist material used in processing of electronic devices, the organic molecular film can be easily removed by a solvent, a plasma, or heating after being processed. Therefore, the organic molecular film can be used as an etching mask. However, this organic molecular film has very high affinity to the surface of the diamond-like carbon film used as the protective layer, and often forms a flat film having a uniform film thickness instead of an island structure.

The present inventors have found that a fine island structure easily forms when the mask underlayer is inserted between the mask pattern layer and protective film.

As the mask pattern layer, a polymer film or organic molecular deposited film formed by coating can be used.

A case in which an isolation structure of a polymer material is used as the island structure of the polymer film will be explained below. As the polymer organic compound, it is possible to use, e.g., polystyrene, polymethylmethacrylate (PMMA), polyimide, novolak resin, polyethylene, polybutadiene, polyisoprene, or polyethylene oxide. It is possible to dissolve any of these polymers in an appropriate solvent, and form a film of the polymer on the mask underlayer by spin coating or dipping. To form an island structure, the film thickness must be decreased to a certain degree or less.

When the film thickness decreases, a polymer film having low affinity to the mask underlayer surface forms a droplet-like isolation structure. It is effective to anneal the formed polymer film in order to form this isolation structure. It is also possible to control the area occupied by the island by annealing. Annealing can further promote the isolation of the polymer film, and decrease the area occupied by the island. An isolation structure of a polymer blend formed by blending two types of polymers may also be used. When this polymer blend is used, a phase isolation structure is formed by annealing a coating film of the polymer blend.

A method of using an island grown structure of a polymer material as the island structure of the organic molecular deposited film will be explained below. As the material of the organic molecular deposited film, it is possible to use any of the materials described in relation to the organic molecular deposited film of the mask underlayer. If the affinity between the low-molecular organic compound and mask underlayer surface is low, island growth can readily occur during vacuum evaporation. It is also desirable to decrease the film thickness of the deposited film to a certain degree or less in order to obtain an isolated island structure. To form an island structure, it is also effective to heat the substrate when a deposited film is formed. Heating the substrate after a deposited film is formed is similarly effective. Either method is effective to control the area occupied by island projections. It is also possible to control the size and occupied area of the island projections by the formation speed of the deposited film. That is, when the formation speed is low, the density of the nuclei of projections which grow into an island increases, so a mask pattern layer made up of high-density island projections can be formed.

After that, as shown in FIG. 6, the mask pattern layer 6 and protective layer 3 are etched (S5) to remove, e.g., exposed portions of the etching underlayer 4 and the surface of the protective layer to a desired depth, thereby forming projections corresponding to the mask pattern layer.

In the present invention, dry etching is used to etch the protective layer. Examples of dry etching used in the present invention are plasma etching and ion beam etching. Oxygen or the like can be used as an etching gas of plasma etching. An inert gas such as argon ions can be used as an etching gas of ion beam etching.

When the protective layer is to be processed by using ion beam etching, the height of the projections of the mask layer is desirably increased because the sputter etching speed of diamond-like carbon is very low.

Note that the etching gas is not limited to oxygen or argon.

Finally, as shown in FIG. 7, the etching mask 6 is removed (S6) to obtain a magnetic recording medium 8 having the protective layer 3 on the surface of which a plurality of fine projections 7 are formed.

Since the residue of the etching mask layer is an aggregate of organic molecules, it can be easily removed by using an organic solvent.

Examples of the organic solvent are alcohols such as ethanol, methanol, and propanol, acetone, toluene, xylene, benzene, chloroform, methylene chloride, propylene glycol methyl ethyl acetate (PGMEA), and ethyl cellosolve acetate.

When an isolation structure of a film such as a photoresist is used as the mask layer, the solubility to an alkaline solution rises by ultraviolet irradiation or electron beam irradiation, and this facilitates removal of the film. When heat decomposable organic molecules are used, it is effective to decompose the organic molecules by heating after an etching process, and then remove the organic molecules by using a solvent. When a material having a low melting point or low sublimation point is used as the mask layer, it is possible to volatilize organic molecules by heating after an etching process. When an island grown structure of an organic deposited film is used as the mask pattern layer, molecules forming the mask pattern layer sublimate and evaporate at a low temperature of 400° C. or less. In a residue removing step, therefore, the residue is readily removable by substrate heating.

Combinations of the mask underlayer and mask pattern layer used in the present invention are closely related to the size and density of island projections of the isolation structure.

As described above, the mask underlayer used in the present invention is a thin film of an inorganic material such as a metal film, metal oxide film, or metal nitride film, or an organic molecular film such as a polymer film or organic molecular deposited film formable by coating. Also, the mask pattern layer is an organic molecular film such as a polymer film or organic molecular deposited film.

When a metal film, metal oxide film, or metal nitride film is to be used as the mask underlayer, a polymer film or organic molecular deposited film can be used as the mask pattern layer. When a polymer film is to be used as the mask underlayer, an organic molecular deposited film can be used as the mask pattern layer. This is so because if polymer films are used as both the mask underlayer and mask pattern layer, the solvent in a coating solution of the mask pattern layer may destroy the mask underlayer when the mask pattern layer is formed by coating.

When polymer films are to be used as both the mask underlayer and mask pattern layer, therefore, it is possible to use, e.g., a fluorine-based polymer as the mask underlayer formation material and a hydrocarbon-based polymer as the mask pattern layer formation material, thereby decreasing the affinity between the mask underlayer surface and mask pattern layer formation material.

When an organic molecular deposited film is to be used as the mask underlayer, an organic molecular deposited film can also be used as the mask pattern layer. This is so because if a polymer film is formed by coating on the mask underlayer made of an organic molecular deposited film, the organic molecular deposited film is readily dissolved by the solvent in the polymer film coating solution.

When organic molecular deposited films are to be used as both the mask underlayer and mask pattern layer, however, if material of the same type is used, the affinity between the mask underlayer surface and mask pattern layer material increases, and this makes an island structure difficult to form.

As a particularly favorable combination, it is possible to use a fluorine-based polymer film as the mask underlayer, and an organic molecular deposited film as a mask pattern layer. In this case, an island structure of the mask pattern layer can be easily obtained because the affinity between the mask underlayer surface and mask pattern layer is low.

After the etching mask layer is removed, a lubricant film (not shown) can be formed on the protective layer by dip coating.

Also, it is sometimes impossible to completely remove a small amount of organic molecules adsorbed in the surface of the diamond-like carbon layer by only the step of removing the residue of the etching mask layer. In this case, after the residue of the etching mask layer is removed, organic molecules adsorbed in the diamond-like carbon film surface can be removed by further performing an etching process.

After that, a thin diamond-like carbon film can also be formed again. This diamond-like carbon film surface adsorbs the lubricant better than the severely damaged surface having undergone dry etching.

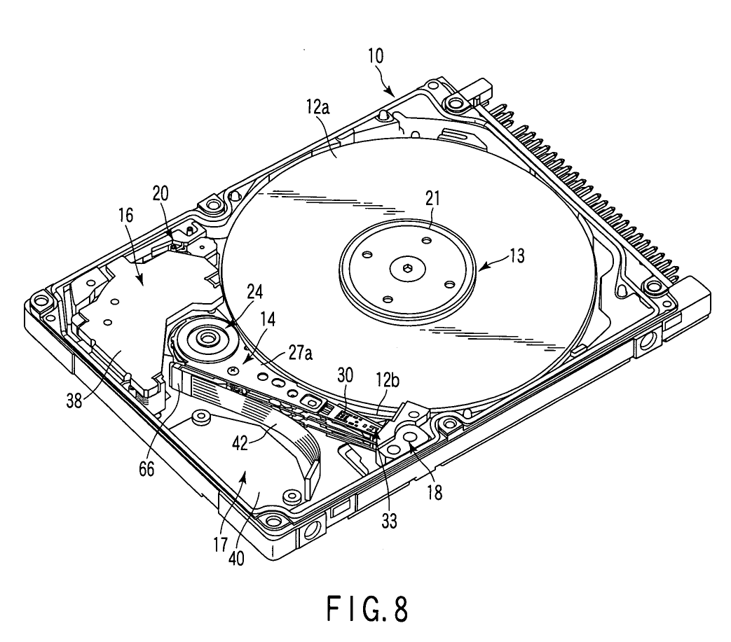

FIG. 8 is a schematic view showing the arrangement of an example of the magnetic recording/reproducing apparatus of the present invention.

As shown in FIG. 8, a hard disk drive (to be referred to as an HDD hereinafter) as a disk device has a rectangular box case 10 having an open upper end, and a top cover (not shown) which is screwed to the case by a plurality of screws to close the upper-end opening of the case.

The case 10 contains a magnetic disk 12 as a recording medium, a spindle motor 13 which supports and rotates the magnetic disk 12, a magnetic head 33 which records and reproduces information on and from the magnetic disk, a head actuator 14 which movably supports the magnetic head 33 with respect to the magnetic disk 12, a voice coil motor (to be referred to as a VCM hereinafter) 16 which rotates and positions the head actuator, a ramped loading mechanism 18 which holds the magnetic head 33 in a position separated from the magnetic disk when the magnetic head moves to the outermost periphery of the magnetic disk, an inertia latching mechanism 20 which holds the head actuator in a retracted position when an impact or the like acts on the HDD, and a flexible printed circuit board unit (to be referred to as an FPC unit hereinafter) 17 on which electronic parts such as a preamplifier are mounted.

A printed circuit board (not shown) which controls the operations of the spindle motor 13, VCM 16, and magnetic head via the FPC unit 17 are screwed to the outer surface of the case 10 so as to face the bottom wall of the case.

The magnetic disk 12 has a diameter of, e.g., 65 mm (2.5 in.), and has a magnetic recording layer. The magnetic disk 12 is fitted on a hub (not shown) of the spindle motor 13, and clamped by a clamp spring 21. The magnetic disk 12 is rotated at a predetermined speed by the spindle motor 13 as a driver.

The magnetic head 33 is a so-called combined head formed on a substantially rectangular slider (not shown). The magnetic head 33 has a write head having a single pole structure, a read head using a GMR film or TMR film, and a magneto resistive (MR) head for recording and reproduction. The magnetic head 33 is fixed together with the slider to a gimbal unit formed on the distal end portion of a suspension.

The present invention will be described in more detail below by way of its examples.

### EXAMPLE 1

In this example, a polymer film was formed as a mask underlayer, and a polymer film made of a polymer material different from the mask underlayer was formed as a mask pattern layer.

A 0.5-mm thick, 1.8-in. crystallized glass substrate (TS10SX manufactured by Ohara) was prepared as a substrate.

To give magnetic anisotropy, this crystallized glass substrate was textured. An arithmetic-mean surface roughness Ra was about 0.3 nm.

After the substrate was cleaned, a sputtering apparatus (C=3010 manufactured by Anelva) was used to form a 10-nm thick underlayer made of a Cr-based alloy on the substrate, a 2-nm thick stabilizing layer made of a CoCrPtB alloy on the underlayer, a 1-nm thick Ru interlayer on the stabilizing layer, a 5-nm thick magnetic recording layer made of a CoCrPtB alloy on the interlayer, and a 5-nm thick protective layer made of diamond-like carbon on the magnetic recording layer. On the protective layer, a 2-nm thick film of Fomblin Z-Tetraol (manufactured by Solvey Solexis) as a perfluoropolyether-based lubricant was formed as a mask underlayer by dip coating.

After that, a 20-nm thick PMMA film was formed as a mask pattern layer by spin coating, thereby forming an etching mask layer made up of the perfluoropolyether-based lubricant layer and PMMA film. Fomblin Z-Tetraol can form a very thin film having a thickness of 5 nm or less, and well repels a film formed on it. Therefore, a droplet-like isolation structure of the polymer film readily formed. Subsequently, the obtained substrate was annealed in a nitrogen ambient at 200° C. for 5 hours.

Then, exposed portions of the mask underlayer and the underlying protective layer were removed to a desired depth by oxygen plasma etching, thereby forming projections corresponding to the mask pattern layer in the same manner as for, e.g., the substrate shown in FIG. 6.

The obtained substrate was irradiated with UV radiation and washed with water. It was readily possible to disconnect the polymer chain of this PMMA film by the UV irradiation, and remove them by the washing with water.

After that, the Fomblin Z-Tetraol and PMMA film remaining of the surface were removed by irradiation with a plasma of, e.g., argon, oxygen, or nitrogen, thereby obtaining a magnetic recording medium having the protective layer on the surface of which a plurality of projections were formed.

When AFM measurements were performed, the sum of the plane areas of summits viewed in a direction perpendicular to the medium surface was 25% of the area of the medium surface.

Also, the average plane area of the summits of the projections viewed in the direction perpendicular to the medium surface was 0.63 μm², and the average height of these projections was 2.8 nm.

Table 1 (to be presented later) shows the obtained results.

The obtained magnetic recording medium was coated with a perfluoropolyether-based lubricant about 2 nm thick as a lubricating layer.

The obtained magnetic recording medium was evaluated by a drive test using a contact head, a drive test using a flying head, and an electro magnetic conversion characteristic test to be described below. Table 2 (to be presented later) shows the obtained results.

The test methods of the individual tests were as follows.

Drive Test Using Contact Head

The magnetic recording medium and a contact magnetic head (Pico slider) having a head load of 2.5 gf were incorporated into a magnetic disk drive, and a full-surface seek test was conducted at 60° C. and 30% RH for 30 days, thereby checking the presence/absence of an error caused by TA or the like. If an error occurred, the evaluation was X; if not, the evaluation was ◯.

Drive Test Using Flying Head

The magnetic recording medium and an ultra-low flying head (Femto slider) having a flying height of 10 nm or less were incorporated into a magnetic disk drive, and a full-surface random seek test was conducted in a reduced-pressure environment at 0.7 atm. After an elapse of 24 hours, deterioration of the performance (the time required for full-surface read/write) and the presence/absence of an error caused by TA were checked. If an error occurred, the evaluation was X; if not, the evaluation was ◯.

Electro magnetic Conversion Characteristic Evaluation

The electro magnetic conversion characteristic was evaluated with a spinstand manufactured by Guzik by combining the magnetic recording medium and ultra-low flying head. The Signal-to-noise ratio of each combination was relatively evaluated with reference to that of a combination of the magnetic recording medium of Comparative Example 2 and the ultra-low flying head.

### EXAMPLE 2

In this example, an organic molecular deposited film was formed as a mask underlayer, and a polymer film was formed as a mask pattern layer.

Following the same procedures as in Example 1, an underlayer, stabilizing layer, interlayer, magnetic recording layer, and protective layer were sequentially formed on a crystallized glass substrate. After that, the substrate was left to stand in HMDS (hexamethyldisilazane) steam for an appropriate time, e.g., 1 hour, thereby forming a single-layered adsorption film of HMDS as a mask underlayer.

After that, a 10-nm-thick film of a solution prepared by diluting the S1801 photoresist manufactured by Chypre with PGMEA was formed on the HMDS single-layered adsorption film by spin coating. Annealing was then performed at 80° C. for 10 minutes to form a mask pattern layer. The photoresist readily formed a droplet-like isolation structure on the HMDS single-layered adsorption film.

Then, exposed portions of the mask underlayer and the underlying protective layer were removed to a desired depth by oxygen plasma etching, thereby forming projections corresponding to the mask pattern layer in the same manner as for, e.g., the substrate shown in FIG. 6.

After that, the obtained substrate was exposed to ultraviolet radiation, and the mask pattern layer was removed by using a developer made of the MF319 manufactured by Chypre. The photoresist used as the mask pattern layer was readily removable after etching by the exposure process and the process using the developer.

Subsequently, the residues of the HMDS layer and mask pattern layer were removed by argon plasma or oxygen plasma, thereby obtaining a magnetic recording medium having the protective layer on the surface of which a plurality of projections were formed.

When AFM measurements were performed, the sum of the plane areas of summits viewed in a direction perpendicular to the medium surface was 35% of the area of the medium surface.

Also, the average plane area of the summits of the projections viewed in the direction perpendicular to the medium surface was 0.18 μm², and the average height of these projections was 2.7 nm.

The obtained magnetic recording medium was coated with a perfluoropolyether-based lubricant about 2 nm thick as a lubricating layer.

Following the same procedures as in Example 1, the obtained magnetic recording medium was evaluated by the drive test using the contact head, the drive test using the flying head, and the electro magnetic conversion characteristic test. Table 2 shows the obtained results.

### EXAMPLES 3A-3E

In each of these examples, a polymer film was formed as a mask underlayer, and an organic molecular deposited film was formed as a mask pattern film.

Following the same procedures as in Example 1, an underlayer, stabilizing layer, interlayer, magnetic recording layer, and protective layer were sequentially formed on a crystallized glass substrate. After that, this substrate was exposed to a plasma of CF₄ or CHF₃ to form an adsorption layer of a fluorocarbon-based polymer as a mask underlayer.

A 6-nm-thick triphenyldiamine layer was then formed as a mask pattern layer by vacuum evaporation on the adsorption layer made of the fluorocarbon-based polymer, thereby obtaining an etching mask layer made up of the fluorocarbon-based polymer adsorption layer and triphenyldiamine layer.

In addition, exposed portions of the mask underlayer and the underlying protective layer were removed to a desired depth by oxygen plasma etching, thereby forming projections corresponding to the mask pattern layer in the same manner as for, e.g., the substrate shown in FIG. 6.

After that, the triphenyldiamine layer was removed by sublimation by heating the obtained substrate to 150° C. or more in a vacuum by using lamp annealing, or removed by acetone as an organic solvent.

Subsequently, the fluorocarbon-based polymer and triphenyldiamine layer remaining on the protective layer surface were removed by irradiation with argon, oxygen, or nitrogen gas plasma, thereby obtaining a magnetic recording medium having the protective layer on the surface of which a plurality of projections were formed.

Separately, various magnetic recording medium samples having protective layers with different three-dimensional structure shapes were formed by changing the film thickness of the triphenyldiamine layer, the film formation rate of the triphenyldiamine layer during vacuum evaporation, and the plasma etching time of the protective layer. Table 1 below shows the AFM measurement results of these samples.

Each obtained magnetic recording medium was coated with a perfluoropolyether-based lubricant about 2 nm thick as a lubricating layer.

In each example, the polymer in CF₄ plasma was used as the mask underlayer, and the organic molecular deposited film was used as the mask pattern layer. Therefore, it was possible to consistently perform all the etching steps of the protective layer in a vacuum, and efficiently manufacture the magnetic recording medium.

Following the same procedures as in Example 1, the obtained magnetic recording media were evaluated by the drive test using the contact head, the drive test using the flying head, and the electro magnetic conversion characteristic test. Table 2 shows the obtained results.

### EXAMPLE 4

In this example, a polymer film was formed as a mask underlayer, and an organic molecular deposited film was formed as a mask pattern layer.

Following the same procedures as in Example 1, an underlayer, stabilizing layer, interlayer, and magnetic recording layer were sequentially formed on a crystallized glass substrate. After that, a 1-nm-thick Pt layer was formed as an etching stop layer by sputtering.

On this etching stop layer, a 2.5-nm-thick protective layer was formed by using diamond-like carbon.

On this protective layer, an etching mask layer including an adsorption layer of a fluorocarbon-based polymer and a 2-nm-thick triphenyldiamine layer was formed following the same procedures as in Example 3.

Exposed portions of the mask underlayer and the underlying protective layer were removed to a desired depth by oxygen plasma etching, thereby forming projections corresponding to the mask pattern layer.

After that, the triphenyldiamine layer was removed by sublimation by heating the obtained substrate to 150° C. or more in a vacuum by using lamp annealing, or removed by acetone as an organic solvent.

Subsequently, the fluorocarbon-based polymer and triphenyldiamine layer remaining on the protective layer surface were removed by irradiation with argon, oxygen, or nitrogen gas plasma.

Since the pattern of the isolation structure of the etching mask is not uniform, the etching rate changes in accordance with the area of a recess as an exposed portion of the mask underlayer, and this varies the heights of the projections formed on the protective layer. However, the etching stop layer can make all the projections formed on the protective layer of uniform height.

Subsequently, a 1-nm-thick protective layer was formed on top of the substrate by using diamond-like carbon.

By thus further forming the diamond-like carbon layer on the patterned surface of the protective layer after the etching mask layer is removed, it is possible to planarize the protective layer surface deteriorated by etching, and obtain a protective layer having high hardness.

When AFM measurements were performed, the sum of the plane areas of summits viewed in a direction perpendicular to the medium surface was 21% of the area of the medium surface.

Also, the average plane area of the summits of the projections viewed in the direction perpendicular to the medium surface was 0.20 μm², and the average height of these projections was 2.1 nm.

The obtained magnetic recording medium was coated with a perfluoropolyether-based lubricant about 2 nm thick as a lubricating film.

Following the same procedures as in Example 1, the obtained magnetic recording medium was evaluated by the drive test using the contact head, the drive test using the flying head, and the electro magnetic conversion characteristic test. Table 2 shows the obtained results.

### EXAMPLE 5

In this example, a metal film was formed as a mask underlayer, and an organic molecular deposited film was formed as a mask pattern layer.

Following the same procedures as in Example 1, an underlayer, stabilizing layer, interlayer, magnetic recording layer, and protective layer were sequentially formed on a crystallized glass substrate. After that, a 1-nm-thick Si film was formed as a mask underlayer by sputtering.

Then, a 1-nm-thick triphenyldiamine layer was deposited as a mask pattern layer on the Si film in a vacuum, thereby obtaining an etching mask made up of the Si film and triphenyldiamine deposited layer.

After that, exposed portions of the mask underlayer and the underlying protective layer were removed to a desired depth by oxygen plasma etching, thereby forming projections corresponding to the mask pattern layer in the same manner as for, e.g., the substrate shown in FIG. 6.

In addition, a diamond-like carbon layer was processed by oxygen plasma etching.

After that, the triphenyldiamine layer was removed by sublimation by heating the obtained substrate to 150° C. or more in a vacuum by using lamp annealing, or removed by acetone as an organic solvent.

Subsequently, the Si mask underlayer was removed by exposing the obtained substrate to CF₄ plasma.

Furthermore, the polymer material remaining on the protective layer surface was removed by irradiation with argon, oxygen, or nitrogen gas plasma.

The obtained magnetic recording medium was coated with a perfluoropolyether-based lubricant about 2 nm thick as a lubricating layer.

In this example, the metal film Si was used as the mask underlayer, and the organic molecular deposited film was used as the mask pattern layer. Therefore, it was possible to consistently perform all the etching steps of the protective layer in a vacuum, and efficiently manufacture the magnetic recording medium.

Following the same procedures as in Example 1, the obtained magnetic recording medium was evaluated by the drive test using the contact head, the drive test using the flying head, and the electro magnetic conversion characteristic test. Table 2 shows the obtained results.

### EXAMPLE 6

In this example, a polymer film was formed as a mask underlayer, and an organic molecular deposited film was formed as a mask pattern layer.

Following the same procedures as in Example 1, an underlayer, stabilizing layer, interlayer, magnetic recording layer, and protective layer were sequentially formed on a crystallized glass substrate. After that, a 2-nm-thick layer of Fomblin Z-Tetraol (manufactured by Solvey Solexis) as a perfluoropolyether-based lubricant was formed as a mask underlayer by dip coating.

Then, triphenyldiamine was used to form a 4-nm-thick mask pattern layer by vacuum evaporation, thereby obtaining an etching mask layer made up of the perfluoropolyether-based lubricant layer and triphenyldiamine layer. It was readily possible to form a fine isolation structure by using the perfluoropolyether-based lubricant as the mask underlayer, and the organic molecular deposited film as the mask pattern layer.

In addition, exposed portions of the mask underlayer and the underlying protective layer were removed to a desired depth by oxygen plasma etching, thereby forming projections corresponding to the mask pattern layer in the same manner as for, e.g., the substrate shown in FIG. 6.

After that, the triphenyldiamine layer was removed by sublimation by heating the obtained substrate to 150° C. or more in a vacuum by using lamp annealing, or removed by acetone as an organic solvent.

Subsequently, the fluorocarbon-based polymer and triphenyldiamine layer remaining on the protective layer surface were removed by irradiation with argon, oxygen, or nitrogen gas plasma, thereby obtaining a magnetic recording medium having the protective layer on the surface of which a plurality of projections were formed.

The obtained magnetic recording medium was coated with a perfluoropolyether-based lubricant about 2 nm thick as a lubricating layer.

Following the same procedures as in Example 1, the obtained magnetic recording medium was evaluated by the drive test using the contact head, the drive test using the flying head, and the electro magnetic conversion characteristic test. Table 2 shows the obtained results.

### EXAMPLE 7

In this example, a metal film was formed as a mask underlayer, and a polymer film was formed as a mask pattern layer.

Following the same procedures as in Example 1, an underlayer, stabilizing layer, interlayer, magnetic recording layer, and protective layer were sequentially formed on a crystallized glass substrate. After that, a 1-nm-thick Si film was formed as a mask underlayer by sputtering.

Then, a 20-nm-thick PMMA film was formed as a mask pattern layer by spin coating, thereby forming an etching mask made up of the Si film and PMMA film.

When the PMMA film was formed on the Si film, the formation of an island structure was readily possible, and relatively large islands having high durability were obtained.

Subsequently, the obtained substrate was further annealed in a nitrogen ambient at 200° C. for 5 hours.

In addition, exposed portions of the mask underlayer and the underlying protective layer were removed to a desired depth by oxygen plasma etching, thereby forming projections corresponding to the mask pattern layer in the same manner as for, e.g., the substrate shown in FIG. 6.

After that, the obtained substrate was irradiated with UV radiation and washed with water to remove the PMMA film.

Furthermore, the Si mask underlayer was removed by exposing the obtained substrate to CF₄ plasma.

Subsequently, the Si and PMMA layer remaining on the protective layer surface were removed by irradiation with argon, oxygen, or nitrogen gas plasma.

The obtained magnetic recording medium was coated with a perfluoropolyether-based lubricant about 2 nm thick as a lubricating layer.

Following the same procedures as in Example 1, the obtained magnetic recording medium was evaluated by the drive test using the contact head, the drive test using the flying head, and the electro magnetic conversion characteristic test. Table 2 shows the obtained results.

### EXAMPLE 8

In this example, a metal oxide film was formed as a mask underlayer, and an organic molecular deposited film was formed as a mask pattern layer.

Following the same procedures as in Example 1, an underlayer, stabilizing layer, interlayer, magnetic recording layer, and protective layer were sequentially formed on a crystallized glass substrate. After that, a 2-nm-thick SiO₂ film was formed as a mask underlayer by sputtering, and the surface of this SiO₂ film was made hydrophobic by leaving the film to stand in HMDS steam for an appropriate time, e.g., 1 hour, thereby forming an HMDS single-layered adsorption film as a surface layer.

On this HMDS single-layered adsorption film, a 4-nm-thick mask pattern layer was formed by vacuum evaporation by using triphenyldiamine.

The affinity to the mask pattern layer was deliberately lowered because the metal oxide SiO₂ having a surface capable of easily reacting with HMDS was used as the mask underlayer, and the HMDS monomolecular adsorption film was formed as the surface layer. Therefore, a fine island structure easily formed when the mask pattern layer was formed.

After that, exposed portions of the mask underlayer and the underlying protective layer were removed to a desired depth by oxygen plasma etching, thereby forming projections corresponding to the mask pattern layer in the same manner as for, e.g., the substrate shown in FIG. 6.

The triphenyldiamine layer was removed by sublimation by heating the obtained substrate to 150° C. or more in a vacuum by using lamp annealing, or removed by acetone as an organic solvent.

Then, the SiO₂ mask underlayer was removed by exposing the obtained substrate to CF₄ plasma.

Furthermore, the polymer material remaining on the protective layer surface was removed by irradiation with argon, oxygen, or nitrogen gas plasma.

The obtained magnetic recording medium was coated with a perfluoropolyether-based lubricant about 2 nm thick as a lubricating layer.

Following the same procedures as in Example 1, the obtained magnetic recording medium was evaluated by the drive test using the contact head, the drive test using the flying head, and the electro magnetic conversion characteristic test. Table 2 shows the obtained results.

### EXAMPLE 9

In this example, an organic molecular deposited film was formed as a mask underlayer, and an organic molecular deposited film different from the mask underlayer was formed as a mask pattern layer.

Following the same procedures as in Example 1, an underlayer, stabilizing layer, interlayer, magnetic recording layer, and protective layer were sequentially formed on a crystallized glass substrate. After that, a 2-nm-thick Alq₃ film was formed as a mask underlayer by vacuum evaporation. The obtained substrate was then annealed in a nitrogen atmosphere at 150° C. for 1 min.

On the Alq₃ film, a 4-nm-thick triphenyldiamine film as a low-molecular organic compound was formed as a mask pattern layer at a substrate temperature of 60° C. by vacuum evaporation.

In addition, exposed portions of the mask underlayer and the underlying protective layer were removed to a desired depth by oxygen plasma etching, thereby forming projections corresponding to the mask pattern layer in the same manner as for, e.g., the substrate shown in FIG. 6.

After that, the triphenyldiamine layer was removed by sublimation by heating the obtained substrate to 150° C. or more in a vacuum by using lamp annealing, or removed by acetone as an organic solvent.

Subsequently, the fluorocarbon-based polymer and triphenyldiamine layer remaining on the protective layer surface were removed by irradiation with argon, oxygen, or nitrogen gas plasma, thereby obtaining a magnetic recording medium having the protective layer on the surface of which a plurality of projections were formed.

The mask underlayer and mask pattern layer were easily removed because both the layers were made of the organic molecular deposited films.

The obtained magnetic recording medium was coated with a perfluoropolyether-based lubricant about 2 nm thick as a lubricating layer.

Following the same procedures as in Example 1, the obtained magnetic recording medium was evaluated by the drive test using the contact head, the drive test using the flying head, and the electro magnetic conversion characteristic test. Table 2 shows the obtained results.

### COMPARATIVE EXAMPLE 1

An underlayer, stabilizing layer, interlayer, and magnetic recording layer were sequentially formed on a crystallized glass substrate following the same procedures as in Example 1, except that chemical mechanical polishing was performed on the surface of the substrate, and a surface roughness Ra was about 1.0 nm. After that, a 3-nm-thick carbon protective layer was formed on the magnetic recording layer, and coated with a perfluoropolyether-based lubricant about 2 nm thick as a lubricating layer.

Following the same procedures as in Example 1, the obtained magnetic recording medium was evaluated by the drive test using the contact head, the drive test using the flying head, and the electro magnetic conversion characteristic test. Table 2 shows the obtained results.

### COMPARATIVE EXAMPLE 2

An underlayer, stabilizing layer, interlayer, and magnetic recording layer were sequentially formed on a crystallized glass substrate. After that, a 3-nm thick carbon protective layer was formed and coated with a perfluoropolyether-based lubricant about 2 nm thick as a lubricating layer.

Following the same procedures as in Example 1, the obtained magnetic recording medium was evaluated by the drive test using the contact head, the drive test using the flying head, and the electro magnetic conversion characteristic test. Table 2 below shows the obtained results.

TABLE 1

| | | | Projection average |
|---|---|---|---|
| | Projection area | Projection average | height |
| | ratio (%) | area (μm²) | (nm) |
| Example 1 | 25 | 0.63 | 2.8 |
| Example 2 | 35 | 0.18 | 2.7 |
| Example 3a | 20 | 0.02 | 2.3 |
| Example 3b | 41 | 0.80 | 1.8 |
| Example 3c | 30 | 1.20 | 3.0 |
| Example 3d | 22 | 0.08 | 4.1 |
| Example 3e | 37 | 0.56 | 0.9 |
| Example 4 | 21 | 0.20 | 2.1 |
| Example 5 | 35 | 0.80 | 3.5 |
| Example 6 | 20 | 0.10 | 3.0 |
| Example 7 | 31 | 0.71 | 3.1 |
| Example 8 | 28 | 0.35 | 2.6 |
| Example 9 | 23 | 0.09 | 2.8 |

| | |
|---|---|
| Comparative | — |
| Example 1 | |
| Comparative | — |
| Example 2 | |

TABLE 2

| | | | Electromagnetic | |
|---|---|---|---|---|
| | | | conversion characteristic | |
| | Drive test results | | signal-to-noise ratio (dB) | |
| | Contact head | Flying head | Contact head | Flying head |
| Example 1 | ◯ | ◯ | +1.2 | — |
| Example 2 | ◯ | ◯ | +1.3 | — |
| Example 3a | ◯ | ◯ | +2.0 | — |
| Example 3b | Untestable | ◯ | Immeasurable | — |
| Example 3c | X | ◯ | — | — |
| Example 3d | ◯ | X | — | — |
| Example 3e | Untestable | ◯ | Immeasurable | — |
| Example 4 | ◯ | ◯ | +1.7 | — |
| Example 5 | ◯ | ◯ | +1.3 | — |
| Example 6 | ◯ | ◯ | +1.6 | — |
| Example 7 | ◯ | ◯ | +1.3 | — |
| Example 8 | ◯ | ◯ | +1.4 | — |
| Example 9 | ◯ | ◯ | +1.5 | — |
| Comparative | ◯ | ◯ | +0.5 | −1.3 |
| Example 1 | | | | |
| Comparative | Untestable | X | Immeasurable | Reference ±0 |
| Example 2 | | | | |

In the drive test using the contact head, Examples 3b and 3e and Comparative Example 2 each having low roughness were untestable because the contact head could not be positioned. To stably move the contact head, the sum of the plane areas of summits viewed in a direction perpendicular to the medium surface is desirably 40% or less of the area of the medium surface, and the average height of the projections is desirably 1 nm or less. In Example 3c, TA occurred because the projection size was large. To prevent TA, the average area of the projections is desirably 1 μm² or less. No error occurred in other examples.

In the drive test using the flying head, TA occurred in Example 3d because the projections were high. To prevent TA, the projection height is desirably 4 nm or less. In Comparative Example 2, an error occurred presumably because the roughness was too low and so the magnetic recording medium was damaged by an unexpected contact. An appropriate roughness is necessary to ensure reliability when an ultra-low flying head is used. No error occurred in other examples.

In the electro magnetic conversion characteristic evaluation, when Comparative Example 1 and the ultra-low flying head were combined, the Signal-to-noise ratio decreased by 1.3 dB from the reference because the substrate was roughened and no magnetic anisotropy was imparted. When Comparative Example 1 was combined with the contact head, the Signal-to-noise ratio increased by 0.5 dB by the effect of narrowing the spacing between the magnetic head and magnetic recording medium. When Examples 1, 2, 3a, and 4 to 9 were combined with the contact head, the effect of narrowing the spacing well appeared because the alignment of the magnetic film did not deteriorate and magnetic anisotropy was imparted. As a consequence, the S/N value increased by 1.2 to 2.0 dB from the reference.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic recording medium comprising a substrate, a magnetic recording layer formed on the substrate, and a protective layer formed on the magnetic recording layer, substantially made of diamond-like carbon, and having a plurality of projections formed on a surface thereof, wherein the projections are formed by forming, on the protective layer, an etching mask comprising a mask underlayer and a mask pattern layer stacked on the mask underlayer and having an island structure, and performing dry etching thereafter.

2. A medium according to claim 1, wherein the mask underlayer contains a layer made of a material selected from the group consisting of a metal, a metal oxide, a metal nitride, and an organic molecular material.

3. A medium according to claim 2, wherein the metal contains at least one member selected from the group consisting of silicon, titanium, and tungsten.

4. A medium according to claim 3, wherein a surface of the mask underlayer is treated by a material selected from the group consisting of a silane coupling agent, a photo setting resin, and a thermosetting resin.

5. A medium according to claim 2, wherein the metal oxide and the metal nitride are members selected from the group consisting of SiO₂, Si₃N₄, TiO, and Al₃O₄.

6. A medium according to claim 5, wherein a surface of the mask underlayer is treated by a material selected from the group consisting of a silane coupling agent, a photo setting resin, and a thermosetting resin.

7. A medium according to claim 1, wherein the mask pattern layer is formed by using a material having low affinity to a surface of the mask underlayer.

8. A medium according to claim 1, wherein the mask pattern layer is made of an organic molecular material.

9. A medium according to claim 8, wherein the organic molecular material is a member selected from the group consisting of tetratriphenylaminoethylene, triphenyldiamine, and trishydroxyquinolinoaluminum.

10. A medium according to claim 8, wherein the organic molecular material is a member selected from the group consisting of polystyrene, polymethylmethacrylate, polyimide, novolak resin, polyethylene, polybutadiene, polyisoprene, polyethylene oxide, polydimethylsiloxane, spin on glass, and perfluoropolyether.

11. A medium according to claim 1, wherein an average plane area of summits of the projections viewed in a direction perpendicular to a medium surface is not more than 1 μm².

12. A medium according to claim 1, wherein an average height of the projections is 1 to 4 nm.

13. A medium according to claim 1, wherein a sum of plane areas of summits of the projections viewed in a direction perpendicular to a medium surface is not more than 40% of an area of the medium surface.

14. A magnetic recording medium comprising a substrate, a magnetic recording layer formed on the substrate, and a protective layer formed on the magnetic recording layer, substantially made of diamond-like carbon, and having a plurality of projections formed on a surface thereof,
wherein an average plane area of summits of the projections viewed in a direction perpendicular to a medium surface is not more than 1 μm².

15. A medium according to claim 14, wherein an average height of the projections is 1 to 4 nm.

16. A medium according to claim 14, wherein a sum of plane areas of the summits of the projections viewed in the direction perpendicular to the medium surface is not more than 40% of an area of the medium surface.

17. A magnetic recording/reproducing apparatus comprising:
a perpendicular magnetic recording medium comprising a substrate, a magnetic recording layer formed on the substrate, and a protective layer formed on the magnetic recording layer, substantially made of diamond-like carbon, and having a plurality of projections formed on a surface thereof, the projections being formed by forming, on the protective layer, an etching mask comprising a mask underlayer and a mask pattern layer stacked on the mask underlayer and having an island structure, and performing dry etching thereafter;
and an MR head.

18. An apparatus according to claim 17, wherein the MR head has a flying height of not more than 10 nm from the magnetic recording medium.

19. An apparatus according to claim 17, wherein the mask underlayer contains a layer made of a material selected from the group consisting of a metal, a metal oxide, a metal nitride, and an organic molecular material.

20. An apparatus according to claim 19, wherein the metal contains at least one member selected from the group consisting of silicon, titanium, and tungsten.

21. An apparatus according to claim 20, wherein a surface of the mask underlayer is treated by a material selected from the group consisting of a silane coupling agent, a photo setting resin, and a thermosetting resin.

22. An apparatus according to claim 19, wherein the metal oxide and the metal nitride are members selected from the group consisting of SiO₂, Si₃N₄, TiO, and Al₃O₄.

23. An apparatus according to claim 22, wherein a surface of the mask underlayer is treated by a material selected from the group consisting of a silane coupling agent, a photo setting resin, and a thermosetting resin.

24. An apparatus according to claim 17, wherein the mask pattern layer is formed by using a material having low affinity to a surface of the mask underlayer.

25. An apparatus according to claim 17, wherein the mask pattern layer is made of an organic molecular material.

26. An apparatus according to claim 25, wherein the organic molecular material is a member selected from the group consisting of tetratriphenylaminoethylene, triphenyldiamine, and trishydroxyquinolinoaluminum.

27. An apparatus according to claim 25, wherein the organic molecular material is a member selected from the group consisting of polystyrene, polymethylmethacrylate, polyimide, novolak resin, polyethylene, polybutadiene, polyisoprene, polyethylene oxide, polydimethylsiloxane, spin on glass, and perfluoropolyether.

28. An apparatus according to claim 17, wherein an average plane area of summits of the projections viewed in a direction perpendicular to a medium surface is not more than 1 μm².

29. An apparatus according to claim 17, wherein an average height of the projections is 1 to 4 nm.

30. An apparatus according to claim 17, wherein a sum of plane areas of summits of the projections viewed in a direction perpendicular to a medium surface is not more than 40% of an area of the medium surface.

31. A magnetic recording/reproducing apparatus comprising:
a perpendicular magnetic recording medium comprising a substrate, a magnetic recording layer formed on the substrate, and a protective layer formed on the magnetic recording layer, substantially made of diamond-like carbon, and having a plurality of projections formed on a surface thereof, an average plane area of summits of the projections viewed in a direction perpendicular to a medium surface being not more than 1 μm²;
and an MR head.

32. An apparatus according to claim 31, wherein the MR head has a flying height of not more than 10 nm from the magnetic recording medium.

33. An apparatus according to claim 31, wherein an average height of the projections is 1 to 4 nm.

34. An apparatus according to claim 31, wherein a sum of plane areas of the summits of the projections viewed in the direction perpendicular to the medium surface is not more than 40% of an area of the medium surface.

35. A method of manufacturing a magnetic recording medium, comprising:
forming a magnetic recording layer on a substrate, forming a protective layer made of diamond-like carbon on the magnetic recording layer, forming a mask underlayer on the protective layer, forming a mask pattern layer having an island structure on the mask underlayer to obtain an etching mask made up of the mask underlayer and the mask pattern layer, dry-etching the protective layer by using the etching mask to form a plurality of projections on a surface of the protective layer, and removing the etching mask.

36. A method according to claim 35, wherein the mask underlayer contains a layer made of a material selected from the group consisting of a metal, a metal oxide, a metal nitride, and an organic molecular material.

37. A method according to claim 36, wherein the metal contains at least one member selected from the group consisting of silicon, titanium, and tungsten.

38. A method according to claim 37, wherein a surface of the mask underlayer is treated by a material selected from the group consisting of a silane coupling agent, a photo setting resin, and a thermosetting resin.

39. A method according to claim 36, wherein the metal oxide and the metal nitride are members selected from the group consisting of SiO₂, Si₃N₄, TiO, and Al₃O₄.

40. A method according to claim 39, wherein a surface of the mask underlayer is treated by a material selected from the group consisting of a silane coupling agent, a photo setting resin, and a thermosetting resin.

41. A method according to claim 35, wherein the mask pattern layer is formed by using a material having low affinity to a surface of the mask underlayer.

42. A method according to claim 35, wherein the mask pattern layer is made of an organic molecular material.

43. A method according to claim 42, wherein the organic molecular material is a member selected from the group consisting of tetratriphenylaminoethylene, triphenyldiamine, and trishydroxyquinolinoaluminum.

44. A method according to claim 42, wherein the organic molecular material is a member selected from the group consisting of polystyrene, polymethylmethacrylate, polyimide, novolak resin, polyethylene, polybutadiene, polyisoprene, polyethylene oxide, polydimethylsiloxane, spin on glass, and perfluoropolyether.

45. A method according to claim 35, wherein an average plane area of summits of the projections viewed in a direction perpendicular to a medium surface is not more than 1 μm².

46. A method according to claim 35, wherein an average height of the projections is 1 to 4 nm.

47. A method according to claim 35, wherein a sum of plane areas of summits of the projections viewed in a direction perpendicular to a medium surface is not more than 40% of an area of the medium surface.
